(19) United States
(12) Patent Application Publication
(10) Pub. No.: US 2009/0196593 A1
(43) Pub. Date: Aug. 6, 2009

(54) ADJUSTABLE SURVEILLANCE CAMERA

(76) Inventor: Yi-Jen CHENG, Taichung (TW)

Correspondence Address: PATENTTM.US, P. O. BOX 82788, PORTLAND, OR, 97282-0788, US

(21) Appl. No.: 12/025,456

(22) Filed: Feb. 4, 2008

(51) Int. Cl. G03B 15/03; G03B 17/00

(52) U.S. Cl. 396/155; 396/427

(57) ABSTRACT

A surveillance camera comprises a base, a back plate, a holding bracket, a pivoting bracket, a lens frame, a camera lens assembly and multiple positioning devices. The back plate is attached rotatably to the base along a first rotating axis. A first positioning device is mounted between the base and the back plate and has multiple lumps and cavities engaging respectively with the lumps. The pivoting bracket is pivotally connected to the holding bracket along a pivoting axis, and a second positioning device is mounted between the pivoting bracket and the holding bracket. The lens frame is rotatably attached to the pivoting bracket along a second rotating axis, and a third positioning device is mounted between the pivoting bracket and the lens frame. The camera lens assembly is securely attached to the lens frame. Accordingly, the angle of the camera lens assembly is easily and conveniently adjusted.

### BACKGROUND OF THE INVENTION

1. Field of the Invention

The present invention relates to a surveillance camera, and more particularly to an adjustable surveillance camera that can be easily and conveniently adjusted.

2. Description of Related Art

With reference to FIG. 10, a conventional surveillance camera comprises a base (A), a rotating bracket (B), a positioning device (C), a lens frame (D), a resilient tab (E) and a lens (G). The rotating bracket (B) is rotatably mounted on the base (A). The positioning device (C) is mounted between the base (A) and the rotating bracket (B) to hold the rotating bracket (B) in position relative to the base (A). The lens frame (D) is pivotally mounted on the rotating bracket (B) and has multiple teeth (F). The resilient tab (E) is securely attached to the rotating bracket (B) and engages the teeth in the lens frame (D) to hold the lens frame (D) at desired angular position relative to the rotating bracket (B). The lens is mounted on the lens frame (D).

With such an arrangement, the lens (D) can be rotated in 360° with the rotation of the rotating base (B) relative to the base (A) and be pivoted in 90° with the pivotal rotation of the lens frame (D) relative to the rotating base (B).

To hold the lens frame (D) at a position relative to the rotating base (B), the resilient tab (E) provide a positioning effect to the lens frame (D) with the engagement with the teeth (F). However, the positioning effect provided by the resilient tab (E) will weak when the resilient tab (E) becomes elasticity fatigue, so the conventional surveillance camera is not durable.

Additionally, to adjust the angle of the lens (G) of the conventional surveillance camera is troublesome and time-consuming especially when a cap is attached to the base (A) and encloses the rotating bracket (B) and the lens frame (D). To detach the cap from the base (A) firstly is necessary for the adjusting process of the conventional surveillance camera, and it is inconvenient.

To overcome the shortcomings, the present invention tends to provide a surveillance camera to mitigate or obviate the aforementioned problems.

### SUMMARY OF THE INVENTION

The main objective of the invention is to provide a surveillance camera that can be easily and conveniently adjusted.

The surveillance camera comprises a base, a back plate, a holding bracket, a pivoting bracket, a lens frame, a camera lens assembly, a first positioning device, a second positioning device and a third positioning device. The base has a front, a rear, a chamber, a central hole and a connecting tube. The chamber is defined in the front of the base and has a bottom. The central hole is defined through the bottom of the chamber. The connecting tube is formed on and protrudes from the rear around the central hole. The back plate is attached rotatably to the rear of the base and has a front, a recess and a connecting tube. The front corresponds to and abuts the rear of the base. The recess is defined in the front of the back plate, holds the connecting tube of the base inside and has a bottom. The connecting tube is formed on and protrudes from the bottom of the recess and is rotatably connected with the connecting tube on the body. The first positioning device is mounted between the rear of the base and the front of the back plate and comprises multiple lumps and cavities engaging respectively with the lumps. The holding bracket is mounted securely in the chamber of the base and comprises a bottom board and two pivoting arms. The bottom board is securely attached to the bottom of the chamber and has two sides. The pivoting arms respectively are formed on and protrude from two sides of the bottom board. The pivoting bracket is pivotally connected to the holding bracket and comprises a supporting board and two pivoting arms. The supporting board has a lens hole defined through the supporting board and two sides. The pivoting arms respectively are formed on and protrude from the sides of the supporting board and are pivotally connected respectively to the pivoting arms on the holding bracket. The second positioning device is mounted between one of the pivoting arms on the pivoting bracket and a corresponding pivoting arm on the holding bracket and comprises multiple lumps and cavities engaging respectively with the lumps. The lens frame is rotatably attached to the supporting board of the pivoting bracket and has a lens hole defined through the lens frame and aligning with the lens hole in the supporting board. The third positioning device is mounted between the supporting board and the lens frame and comprises multiple lumps and cavities engaging respectively with the lumps. The camera lens assembly is securely attached to the lens frame and comprises a lens frame and a camera lens. The lens bracket is securely attached to the lens frame. The camera lens is mounted on the lens bracket and extends through the lens holes in the lens frame and pivoting bracket.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a surveillance camera in accordance with the present invention;

FIG. 2 is an exploded perspective view of the surveillance camera in FIG. 1;

FIG. 3 is a top view in partial section of the surveillance camera in FIG. 1;

FIG. 3A is an enlarged cross sectional top view of a second positioning device of the surveillance camera in FIG. 3;

FIG. 3B is an enlarged cross sectional top view of a third positioning device of the surveillance camera in FIG. 3;

FIG. 4 is an enlarged cross sectional side view of a base and a back plate of the surveillance camera in FIG. 1;

FIG. 5 is an exploded perspective view of a pivoting bracket, a lens frame and a camera lens assembly of the surveillance camera in FIG. 1;

FIG. 6 is an enlarged side view in partial section of the pivoting bracket, the lens frame and the camera lens assembly of the surveillance camera in FIG. 5;

FIG. 7 is an operational perspective view of the surveillance camera in FIG. 1 showing the camera lens being adjusted by turning the base;

FIG. 8 is an operational side view of the surveillance camera in FIG. 1 showing the angular position of the lens being adjusted;

FIG. 9 is an operational perspective view of the surveillance camera in FIG. 1 showing the camera lens being adjusted by turning the lens frame relative to the pivoting bracket; and

FIG. 10 is a side view in partial section of a conventional surveillance camera in accordance with the prior art.

### DETAILED DESCRIPTION OF PREFERRED EMBODIMENT

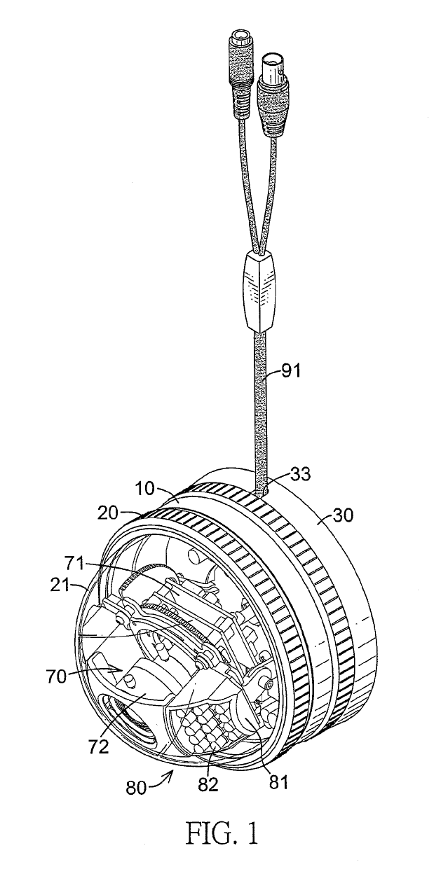

With reference to FIGS. 1 to 3, a surveillance camera in accordance with the present invention comprises a base (10), a back plate (30), a holding bracket (40), a pivoting bracket (50), a lens frame (60), a camera lens assembly (70), multiple positioning devices (34,54,62), a shade (21), a circuit board (90) and an infrared light emitting diode (LED) assembly (80).

The base (10) has a front, a rear, a chamber (11), a central hole (12) and a connecting tube (13).

The chamber (11) is defined in the front of the base (10) and has a bottom. The central hole (12) is defined through the bottom of the chamber (11). The connecting tube (13) is formed on and protrudes from the rear around the central hole (12). The connecting tube (13) has a hooking flange (131) formed around an inner surface of the connecting tube (13).

The back plate (30) is attached rotatably to the rear of the base (10) along a first rotating axis, is securely attached to a wall or ceiling with fasteners and has a front, a recess (31), a connecting tube (32) and wire slot (33).

The front of the back plate (30) corresponds to and abuts the rear of the base (10). The recess (31) is defined in the front of the back plate (30), holds the connecting tube (13) inside and has a bottom. The connecting tube (32) is formed on and protrudes from the bottom of the recess (31) and is rotatably connected with the connecting tube (13) on the body (10). The connecting tube (32) of the back plate (30) has a hooking flange (321) and multiple slits (322). The hooking flange (321) is formed around an outer surface of the connecting tube (32) and engages the hooking flange (131) on the connecting tube (13) of the base (10). With the engagement between the hooking flanges (131,321), the back plate (30) is securely but rotatably connected with the base (10). The slits (322) are defined longitudinally through the connecting tube (32) of the back plate (30) to make the connecting tube (322) compressible and resilient. The wire slot (33) is defined in the front of the back plate (30) and communicates with the recess (31).

The first positioning device (34) is mounted between the rear of the base (10) and the front of the back plate (30) and comprises multiple lumps (341) and cavities (342) engaging respectively with the lumps (341). In an embodiment as shown in the drawings, the lumps (341) of the first positioning device (34) are formed on the rear of the base (10). The cavities (342) of the first positioning device (34) are defined in the front of the back plate (30) and engage respectively the lumps (341) on the base (10). In an alternative embodiment, the lumps (341) are formed on the back plate (30), and the cavities (342) are defined in the base (10). With the engagements of the lumps (341) with the cavities (342), the base (10) can be securely held at desired angles relative to the back plate (30).

The holding bracket (40) is mounted securely in the chamber (11) of the base (10) and comprises a bottom board (41), two pivoting arms (42,43) and a pivotal rod (421).

The bottom board (41) is securely attached to the bottom of the chamber (11) and has two sides, a pivoting hole (431), a central hole (411), a wire notch (412) and a bridge (413). The central hole (411) is defined through the bottom board (41). The wire notch (412) is defined in an outer edge of the bottom board (41). The bridge (413) is formed on the bottom board (41) and across the wire notch (412).

The pivoting arms (42,43) respectively are formed on and protrude from two sides of the bottom board (41). The pivotal rod (421) is formed on and protrudes from one of the pivoting arms (42) of the holding bracket (40), and the pivoting hole (431) is defined through the other pivoting arm (43) of the holding bracket (40).

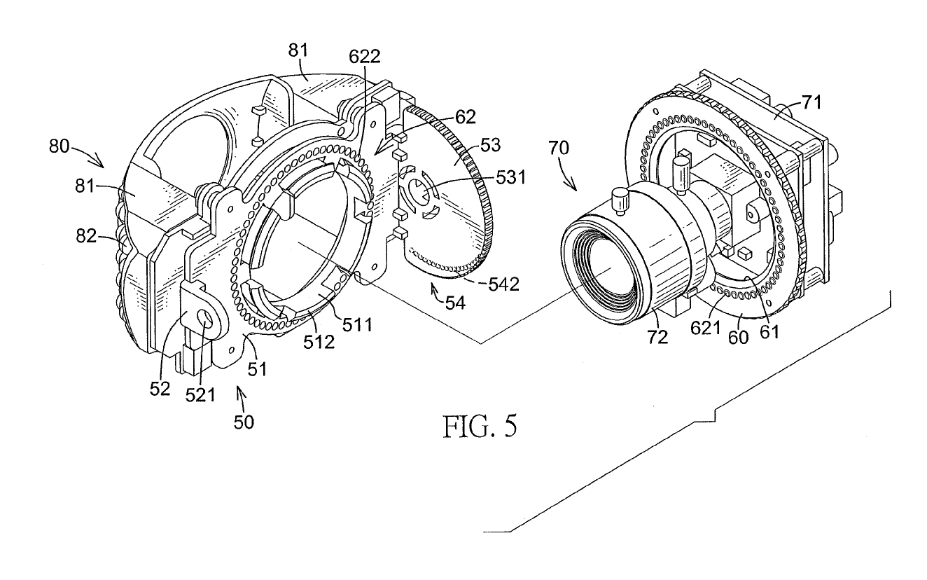

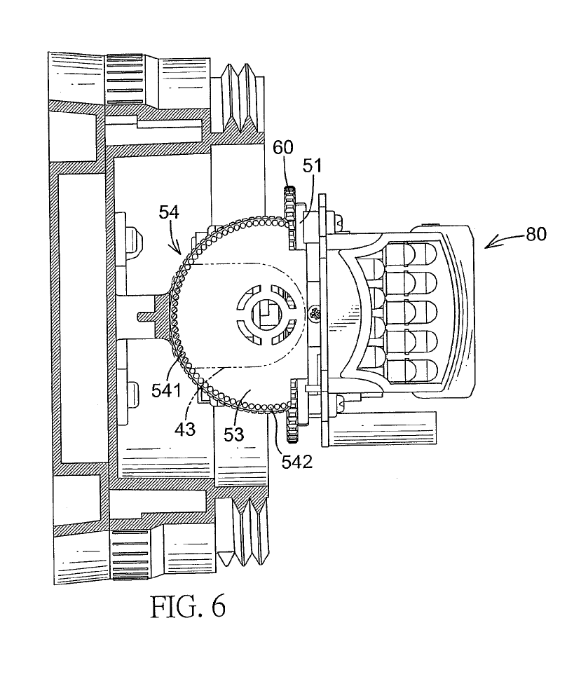

With further reference to FIGS. 5 and 6, the pivoting bracket (50) is pivotally connected to the holding bracket (40) along a pivotal axis that is perpendicular to the first rotating axis between the base (10) and the back plate (30). The pivoting bracket (50) comprises a supporting board (51), two pivoting arms (52,53), a pivotal tube (531) and a pivoting hole (521).

The supporting board (51) has a lens hole (511) defined through the supporting board (51), multiple curved hooks (512) and two sides. The curved hooks (512) are formed around the lens hole (511). The pivoting arms (52,53) respectively are formed on and protrude from the sides of the supporting board (51) and are pivotally connected respectively to the pivoting arms (42.43) on the holding bracket (40). The pivoting hole (521) is defined through one of the pivoting arms (52) of the pivoting bracket (50) and is mounted rotatably around the pivotal rod (421) on the holding bracket (40). The pivotal tube (531) is formed on and protruded from the other pivoting arm (53) of the pivoting bracket (50) and extends rotatably through and engages the pivoting hole (431) in the holding bracket (40).

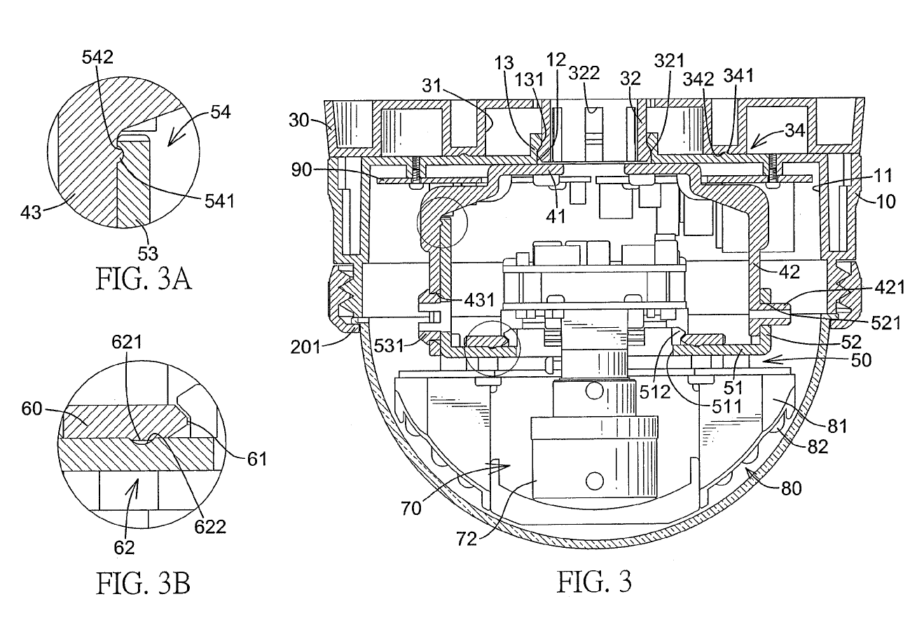

The second positioning device (54) is mounted between one of the pivoting arms (53) on the pivoting bracket (50) and a corresponding pivoting arm (43) on the holding bracket (40) and comprises multiple lumps (541) and cavities (542) engaging respectively with the lumps (541). In an embodiment as shown in FIGS. 3 and 3A, the lumps (541) of the second positioning device (54) are formed on one side of a corresponding pivoting arm (43) of the holding bracket (40). Preferably, the lumps (541) are formed on the pivoting arm (43) of the holding bracket (40) in which the pivoting hole (431) is defined. The cavities (542) of the second positioning device (54) are defined in one side of a corresponding pivoting arm (53) of the pivoting bracket (50), preferably, are defined in the pivoting arm (53) of the pivoting bracket (50) on which the pivotal tube (531) is formed. The cavities (542) engage respectively the lumps (541) on the corresponding pivoting arm (43) of the holding bracket (40) to securely hold the pivoting bracket (50) relative to the holding bracket (40) at desired angles.

In an alternative embodiment, the lumps (541) are formed on the pivoting arm (53) on the pivoting bracket (50), and the cavities (542) are defined in the pivoting arm (43) on the holding bracket (40).

The lens frame (60) is rotatably attached to the supporting board (51) of the pivoting bracket (50) along a second rotating axis that is perpendicular to the pivoting axis between the holding bracket (40) and the pivoting bracket (50). The lens frame (60) has a lens hole (61) defined through the lens frame (60) and aligning with the lens hole (511) in the supporting board (51). The lens hole (61) engages the curved hooks (512) on the supporting board (51) of the pivoting bracket (50), such that the lens frame (60) is rotatably connected with the pivoting bracket (50).

The third positioning device (62) is mounted between the supporting board (51) and the lens frame (60) and comprises multiple lumps (621) and cavities (622) engaging respectively with the lumps (621). In an embodiment as shown in FIGS. 3 and 3B, the lumps (621) of the third positioning device (62) are formed on the lens frame (60). The cavities (622) of the third positioning device (62) are defined in the supporting board (51) of the pivoting bracket (50) and engage respectively the lumps (621) on the lens frame (60). With the engagement between the lumps (621) and the cavities (622), the lens frame (60) will be held in desired angles relative to the pivoting bracket (50). In an alternative embodiment, the lumps (621) are formed on the pivoting bracket (50), and the cavities (622) are defined in the lens frame (60).

The camera lens assembly (70) is securely attached to the lens frame (60) and comprises a lens bracket (71) and a camera lens (72).

The lens bracket (71) is securely attached to the lens frame (60). The camera lens (72) is mounted on the lens bracket (71) and extends through the lens holes (61,511) in the lens frame (60) and pivoting bracket (50).

The shade (21) is transparent, is attached to the base (10) and is mounted around and closes the chamber (11) to hold the holding bracket (40), the pivoting bracket (50), the lens frame (60) and the camera lens assembly (70) between the base (10) and the shade (21). The shade (21) has an annular abutting flange (211) formed around and protruding outwardly from the shade (211) and abutting the front of the base (10). To attach the shade (21) to the base (10), an annular collar (20) is securely attached to the base (10) with a thread manner to hold the shade (21) securely on the base (10). In a preferred embodiment, the annular collar (20) has an inner thread formed in the collar (20), and the base (10) has an outer thread (14) formed around the front of the base (10) and screwed with the inner thread in the collar (20). The annular collar (20) further has an annular engaging flange (201) formed around and protruding inwardly the collar (20) and abutting the abutting flange (211) on the shade (21).

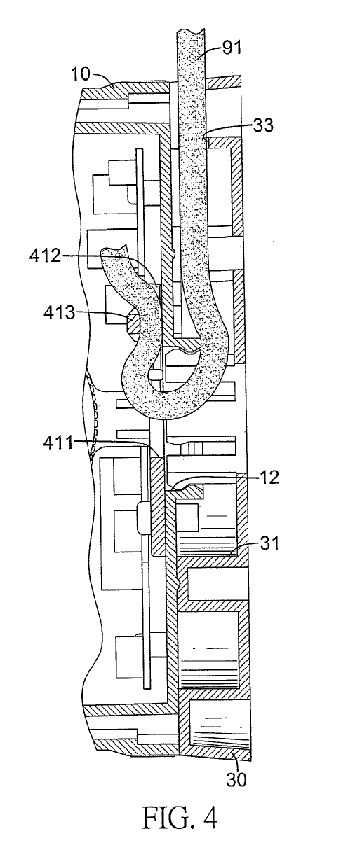

The circuit board (90) is securely attached to the bottom of the chamber (11) in the base (10) and has a wire (91) extending out of the base (10) and back plate (30) and having an outer end provided with plugs. The wire (91) extends through the wire notch (413), the central holes (411,12) in the holding bracket (40) and the base (10), the recess (31) and the wire gap (33) in the back plate (30) and is pressed by the bridge (412) as shown in FIG. 4.

With reference to FIGS. 5 and 6, The infrared light emitting diode (LED) assembly (80) is mounted on the pivoting bracket (50) and comprises two lamp mounts (81) and multiple infrared light emitting diodes (LEDs) (82). The lamp mounts (81) are mounted on the pivoting bracket (50) and are located respectively at two sides of the camera lens (72). The infrared light emitting diodes (LEDs) (82) are mounted respectively in the lamp mounts (81) and are electrically connected to the circuit board (90). With the arrangement of the infrared LED assembly (80), the surveillance camera can be applied in a dark environment, such as a night shot.

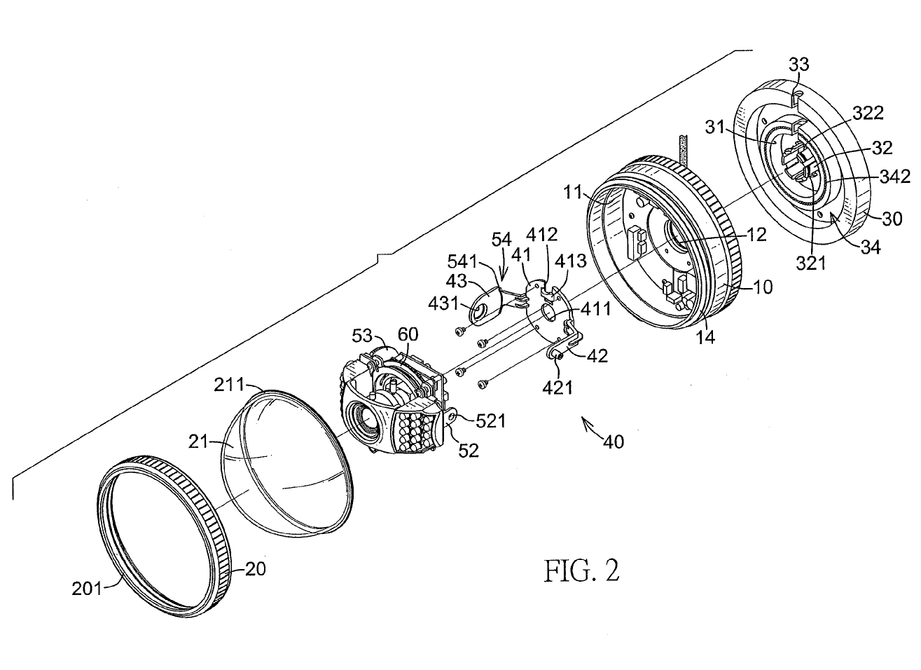

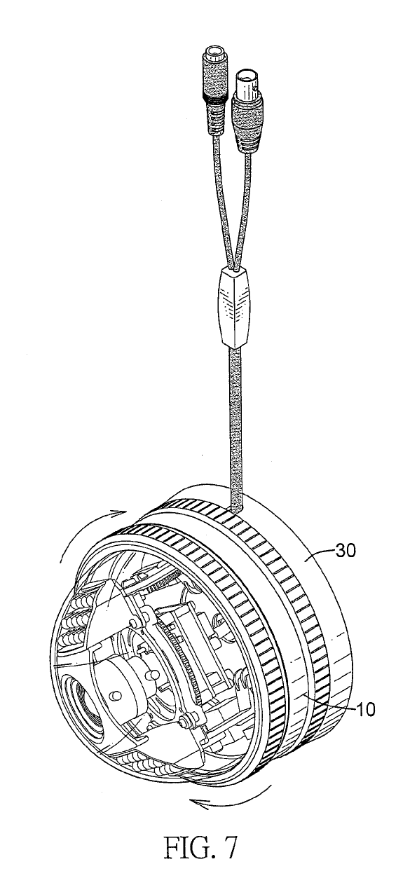

With reference to FIGS. 2 and 7, because the base (10) is rotatably attached to the back plate (30) which is securely attached to a wall or ceiling, the angle of the camera lens (72) can be adjusted along the first rotating axis by turning the base (10) relative to the back plate (30). Accordingly, to detach the shade (21) from the base (10) is unnecessary, to adjust the angle of the camera lens (72) is easily and convenient.

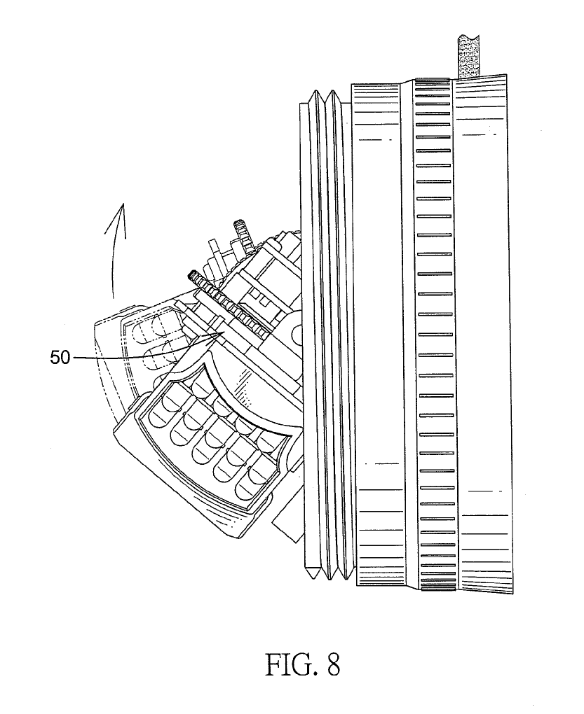

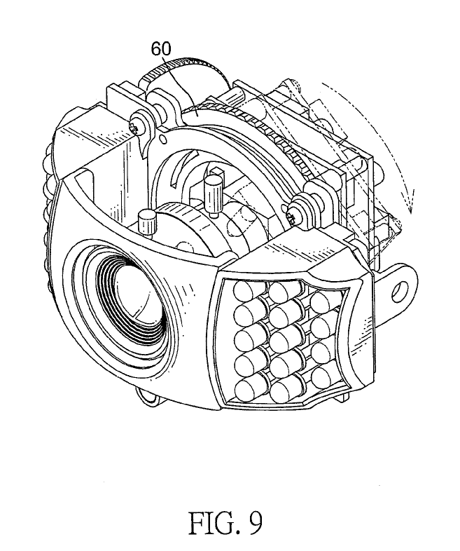

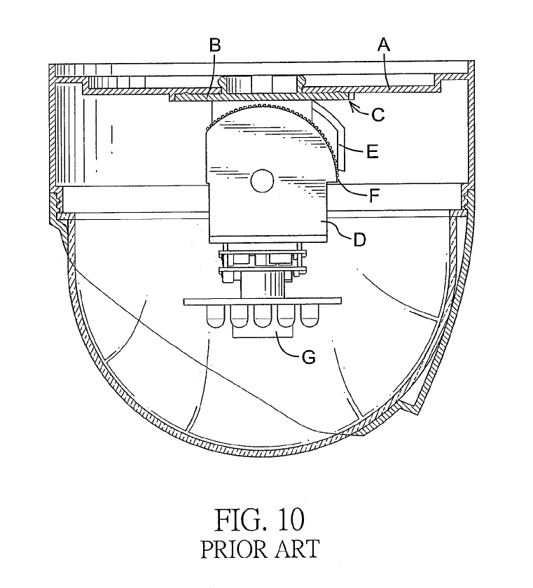

With reference to FIGS. 8 and 9, after the shade (21) being detached from the base (10), the angles of the camera lens (72) can be adjusted along the pivoting axis and the second rotating axis by turning the pivoting bracket (50) or the lens frame (60). Accordingly, the angles of the camera lens (72) can be adjusted easily and conveniently to fit with different needs, such that the surveillance camera is versatile in use no matter that the surveillance camera is mounted on a wall or a ceiling.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A surveillance camera comprising:
a base having
a front;
a rear;
a chamber defined in the front of the base and having a bottom;
a central hole defined through the bottom of the chamber; and
a connecting tube formed on and protruding from the rear around the central hole;
a back plate attached rotatably to the rear of the base and having
a front corresponding to and abutting the rear of the base;
a recess defined in the front of the back plate, holding the connecting tube of the base inside and having a bottom; and
a connecting tube formed on and protruding from the bottom of the recess and rotatably connected with the connecting tube on the body;
a first positioning device mounted between the rear of the base and the front of the back plate and comprising multiple lumps and cavities engaging respectively with the lumps;
a holding bracket mounted securely in the chamber of the base and comprising
a bottom board securely attached to the bottom of the chamber and having two sides; and
two pivoting arms respectively formed on and protruding from two sides of the bottom board;
a pivoting bracket pivotally connected to the holding bracket and comprising
a supporting board having a lens hole defined through the supporting board and two sides; and
two pivoting arms respectively formed on and protruding from the sides of the supporting board and pivotally connected respectively to the pivoting arms on the holding bracket;
a second positioning device mounted between one of the pivoting arms on the pivoting bracket and a corresponding pivoting arm on the holding bracket and comprising multiple lumps and cavities engaging respectively with the lumps;
a lens frame rotatably attached to the supporting board of the pivoting bracket and having a lens hole defined through the lens frame and aligning with the lens hole in the supporting board;
a third positioning device mounted between the supporting board and the lens frame and comprising multiple lumps and cavities engaging respectively with the lumps; and
a camera lens assembly securely attached to the lens frame and comprising
a lens bracket securely attached to the lens frame; and
a camera lens mounted on the lens bracket and extending through the lens holes in the lens frame and pivoting bracket.

2. The surveillance camera as claimed in claim 1 further comprising a transparent shade attached to the base and mounted around and closing the chamber; and
an annular collar securely attached to the base with a thread manner to hold the shade securely on the base, wherein
the shade has an annular abutting flange formed around and protruding outwardly from the shade and abutting the front of the base;
the annular collar has
an annular engaging flange formed around and protruding inwardly the collar and abutting the abutting flange on the shade; and
an inner thread formed in the collar; and
the base has an outer thread formed around the front of the base and screwed with the inner thread in the collar.

3. The surveillance camera as claimed in claim 2, wherein
the back plate further has a wire slot defined in the front of the back plate and communicating with the recess in the back plate;
the bottom board of the holding bracket further has
a central hole defined through the bottom board;
a wire notch defined in an outer edge of the bottom board; and
a bridge formed on the bottom board and across the wire notch; and
a circuit board is securely attached to the bottom of the chamber in the base and has a wire extending through the wire notch, the central holes in the holding bracket and the base, the recess and the wire gap in the back plate and pressed by the bridge.

4. The surveillance camera as claimed in claim 3 further comprising an infrared light emitting diode (LED) assembly mounted on the pivoting bracket and comprising
two lamp mounts mounted on the pivoting bracket and located respectively at two sides of the camera lens; and
multiple infrared light emitting diodes (LEDs) mounted respectively in the lamp mounts and electrically connected to the circuit board.

5. The surveillance camera as claimed in claim 4, wherein
the connecting tube of the base has a hooking flange formed around an inner surface of the connecting tube; and
the connecting tube of the back plate further has
a hooking flange formed around an outer surface of the connecting tube and engaging the hooking flange on the connecting tube of the base; and
multiple slits defined longitudinally through the connecting tube of the back plate to make the connecting tube compressible and resilient.

6. The surveillance camera as claimed in claim 5, wherein
the lumps of the first positioning device are formed on the rear of the base; and
the cavities of the first positioning device are defined in the front of the back plate and engage respectively the lumps on the base.

7. The surveillance camera as claimed in claim 6, wherein
the lumps of the second positioning device are formed on one side of a corresponding pivoting arm of the holding bracket; and
the cavities of the second positioning device are defined in one side of a corresponding pivoting arm of the pivoting bracket and engage respectively the lumps on the corresponding pivoting arm of the holding bracket.

8. The surveillance camera as claimed in claim 7, wherein
the lumps of the third positioning device are formed on the lens frame; and
the cavities of the third positioning device are defined in the supporting board of the pivoting bracket and engage respectively the lumps on the lens frame.

9. The surveillance camera as claimed in claim 8, wherein
the holding bracket further has
a pivotal rod formed on and protruding from one of the pivoting arms of the holding bracket; and
a pivoting hole defined through the other pivoting arm of the holding bracket; and
the pivoting bracket further has
a pivoting hole defined through one of the pivoting arms of the pivoting bracket and mounted rotatably around the pivotal rod on the holding bracket; and
a pivotal tube formed on and protruding from the other pivoting arm of the pivoting bracket and extending rotatably through the pivoting hole in the holding bracket.

10. The surveillance camera as claimed in claim 9, wherein
the lumps of the second positioning device are formed on the pivoting arm of the holding bracket in which the pivoting hole is defined; and
the cavities of the second positioning device are defined in the pivoting arm of the pivoting bracket on which the pivotal tube is formed.

11. The surveillance camera as claimed in claim 10, wherein
the pivoting bracket further has multiple curved hooks formed around the lens hole in the supporting board and engaging the lens hole in the lens frame.

12. The surveillance camera as claimed in claim 1, wherein
the back plate further has a wire slot defined in the front of the back plate and communicating with the recess in the back plate;
the bottom board of the holding bracket further has
a central hole defined through the bottom board;
a wire notch defined in an outer edge of the bottom board; and
a bridge formed on the bottom board and across the wire notch; and
a circuit board is securely attached to the bottom of the chamber in the base and has a wire extending through the wire notch, the central holes in the holding bracket and the base, the recess and the wire gap in the back plate and pressed by the bridge.

13. The surveillance camera as claimed in claim 1 further comprising an infrared light emitting diode (LED) assembly mounted on the pivoting bracket and comprising
two lamp mounts mounted on the pivoting bracket and located respectively at two sides of the camera lens; and
multiple infrared light emitting diodes (LEDs) mounted respectively in the lamp mounts and electrically connected to the circuit board

14. The surveillance camera as claimed in claim 1, wherein
the connecting tube of the base has a hooking flange formed around an inner surface of the connecting tube;
the connecting tube of the back plate further has
a hooking flange formed around an outer surface of the connecting tube and engaging the hooking flange on the connecting tube of the base; and
multiple slits defined longitudinally through the connecting tube of the back plate to make the connecting tube compressible and resilient.

15. The surveillance camera as claimed in claim 1, wherein
the lumps of the first positioning device are formed on the rear of the base; and
the cavities of the first positioning device are defined in the front of the back plate and engage respectively the lumps on the base.

16. The surveillance camera as claimed in claim 1, wherein
the lumps of the second positioning device are formed on one side of a corresponding pivoting arm of the holding bracket; and
the cavities of the second positioning device are defined in one side of a corresponding pivoting arm of the pivoting bracket and engage respectively the lumps on the corresponding pivoting arm of the holding bracket.

17. The surveillance camera as claimed in claim 1, wherein
the lumps of the third positioning device are formed on the lens frame; and
the cavities of the third positioning device are defined in the supporting board of the pivoting bracket and engage respectively the lumps on the lens frame.

18. The surveillance camera as claimed in claim 1, wherein
the holding bracket further has
a pivotal rod formed on and protruding from one of the pivoting arms of the holding bracket; and
a pivoting hole defined through the other pivoting arm of the holding bracket; and
the pivoting bracket further has
a pivoting hole defined through one of the pivoting arms of the pivoting bracket and mounted rotatably around the pivotal rod on the holding bracket; and
a pivotal tube formed on and protruding from the other pivoting arm of the pivoting bracket and extending rotatably through the pivoting hole in the holding bracket.

19. The surveillance camera as claimed in claim 18, wherein
the lumps of the second positioning device are formed on the pivoting arm of the holding bracket in which the pivoting hole is defined; and
the cavities of the second positioning device are defined in the pivoting arm of the pivoting bracket on which the pivotal tube is formed.

20. The surveillance camera as claimed in claim 1, wherein
the pivoting bracket further has multiple curved hooks formed around the lens hole in the supporting board and engaging the lens hole in the lens frame.
